(19) United States
(12) Patent Application Publication
(10) Pub. No.: US 2018/0134899 A1
(43) Pub. Date: May 17, 2018

(54) Renewable Pyrolysis-Gas Derived Carbon Black Material and Method of Making the Same

(71) Applicant: Carbon Research & Development Co., Daytona Beach Shores, FL (US)

(72) Inventor: Daniel Mulqueen, Charleston, SC (US)

(73) Assignee: Carbon Research & Development, Co., Daytona Beach Shores, FL (US)

(21) Appl. No.: 15/809,867

(22) Filed: Nov. 10, 2017

Related U.S. Application Data
(60) Provisional application No. 62/420,876, filed on Nov. 11, 2016.

(51) Int. Cl. C09C 1/48; C09C 1/60

(52) U.S. Cl. CPC C09C 1/48; C09C 1/60; C01P 2006/80; C01P 2006/11; C01P 2006/12

(57) ABSTRACT

A method for the production of a carbon black entirely from raw biomass feedstock by pyrolytically decomposing the biomass feedstock in a controlled processing atmosphere at a preselected temperature for a preselected period of time to produce solid carbon material and wood gas, and using the wood gas as a fuel to pyrolyze added oils in a carbon black furnace to produce carbon black and gaseous by-products for processing the biomass feedstock. The carbon material has a carbon content of greater than 90% by volume of non-volatile, high purity fixed elemental carbon, is free of environmentally hazardous chemical compounds and components surface area, and includes specific properties, such as density, hardness, or chemical composition to provide superior properties in diverse applications.

### CROSS REFERENCE TO RELATED APPLICATIONS

This application claims the benefit of U.S. Provisional Patent Application Ser. No. 62/420,876 filed Nov. 11, 2016, which is incorporated herein by reference in its entirety as if fully set forth herein.

### FIELD OF THE INVENTION

The present invention relates to a novel composition of matter having application for use as a reinforcing agent and filler in rubbers and plastics as well as a pigment and the method for its manufacture. More specifically, the present invention relates to a novel carbon material and the method for its manufacture for use as a carbon black material, as a binder in rubbers and plastics, a pigment, and in other applications where carbon blacks are used.

### BACKGROUND OF THE INVENTION

Carbon black describes a category of materials characterized by a very high purity of elemental carbon, a very small particle size on the order of microns, and a high surface-area-to-volume ratio. Carbon black materials are used broadly in applications as a reinforcing material in the production of rubbers and plastics, as a pigment, and in other diverse industrial applications where its properties are used to improve the functional characteristics of materials.

Carbon black has been produced primarily by two processes, the thermal process and the furnace process. Since the 1970's, most carbon blacks have been produced using the furnace process and are referred to as furnace blacks. The furnace process uses a heavy oil as a feedstock, which is sprayed into a hot reactor (heated by combustion of natural gas or another fuel) under carefully controlled conditions so that the oil pyrolyzes into small carbon black particles. The thermal process uses a pair of furnaces which cycle between heating (using natural gas as a fuel) and the over rich reaction of natural gas, which decomposes into hydrogen and carbon black.

Both of these processes rely on the use of fossil fuels as feedstock and fuel. Fossil fuel usage results in the production of over two tonnes of fossil CO2 emitted per tonne of carbon black produced, a highly undesirable consequence of the process.

A third process, known as the Channel Process has fallen out of favor due to low yields and environmental issues. In this process, partially combusted fuel is brought into contact with a cooled metal channel where the carbon black is formed. This can provide useful surface chemistry and low contamination of other compounds.

Precipitated Silica has been used as a replacement for carbon black, however the cost of these materials is roughly double the cost of similar carbon black materials.

U.S. Pat. No. 2,961,300 A, entitled “Carbon Black Furnace and Operation”, issued to Robert E. Dollinger on Nov. 22, 1960 (the “'300 patent”), describes a carbon black furnace in which a fuel, either gas or oil, is burned to produce heat and a feed-stock, an aromatic gas-oil is injected to produce a carbon black. Air or steam is used to control the reaction temperature. This is an older patent which shows the early history of the art.

U.S. Pat. No. 7,431,909 B1, for “Process for Production of Carbon Black,” issued to Frederick H. Rumpf, et al. on Oct. 7, 2008 (the “'909 patent”), describes a process where the waste gas from one carbon black furnace is used to heat a second carbon black furnace. The '909 patent demonstrates the potential to drive a carbon black process from a waste gas, but the initial firing still requires the use of fossil fuels.

WO2013170358 A1, “Pyrolytic Oil for the Manufacturing of Carbon Black,” published by Wing-Yam Wong on May 14, 2013 (the “'358 publication”) describes a method for the pyrolysis of tires to produce a pyrolysis oil and pyrolysis gas which may be used to produce carbon black. This method makes use of a waste material, but also must account for the high levels of sulfur and other elements used in tire manufacturing.

In view of the foregoing, it is apparent that a need exists for a new and useful material which is has properties similar to thermal and furnace carbon blacks, but which can be produced renewably and without the emission of fossil carbon dioxide or other pollutants into the environment.

### SUMMARY OF THE INVENTION

In an embodiment, the present invention provides a method for the creation of a novel composition of carbon black created through the use of a gaseous fuel produced as a result of the pyrolysis and carbonization of biomass, herein referred to as “pyrolysis-gas” which is used in place of natural gas and oil in the production of carbon black.

In another embodiment of the present invention, a novel composition of carbon material is provided which is free of polycyclic aromatic hydrocarbons and other similar hazardous compounds.

In yet another embodiment of the present invention, a process for producing carbon black material is provided which produces a sustainable final product free of any net release of carbon dioxide or other greenhouse gases into the atmosphere in the life cycle of the product.

These and other advantages and novel features of the present invention will become apparent from the following description of the invention when considered in conjunction with the accompanying drawings and appended claims.

### BRIEF DESCRIPTION OF THE DRAWINGS

FIG. 1 is a flow diagram of a process for the production and sizing of primary and secondary carbon black products in which a gaseous by-product of the pyrolysis and carbonization of a green biomass feedstock is used as a fuel for the steps of the process in accordance with an embodiment. Green biomass is introduced to the dryer, where moisture is driven off. Dry biomass is introduced into the carbonization reactor, where it is thermally decomposed at high temperature into solid carbon and wood gas. The wood gas is burned in the carbon black furnace to provide heat for the pyrolysis of the feedstock oil into carbon black. Waste hot gases from this process are utilized for wood drying, and the carbon black is sized. The solid carbon from carbonization is milled, along with oversized carbon black from the furnace, and the milled carbon is then sized for the desired specification. Particles below the desired size are collected as final product, while the oversized particles are re-introduced into the milling step. This creates a secondary carbon black product.

FIG. 2 is a flow diagram of a process for the production and sizing of a carbon black product in which a gaseous by-product of the pyrolysis and carbonization of a green biomass feedstock is used as a fuel for the steps of the process and a wood tar pyrolysis and carbonization by-product is further pyrolyzed into carbon black. Green biomass is introduced to the dryer, where moisture is driven off. Dry biomass is introduced into the carbonization reactor, where it is thermally decomposed at high temperature into solid carbon, wood gas, and wood tar. Solid carbon exits the system as a secondary product. The wood gas is burned in the carbon black furnace to provide heat for the pyrolysis of the wood tar into carbon black. Waste hot gases from this process are utilized for wood drying, and the carbon black is sized. Particles below the desired size are collected as final product, while the oversized particles are collected as an alternate product.

### DESCRIPTION OF THE PREFERRED EMBODIMENTS

It should be noted that the present description is by way of instructional examples, and the concepts presented herein are not limited to use or application with any single method and/or apparatus for the production of a contaminant remediation material. Hence, while the details of the innovation described herein are for the convenience of illustration and explanation with respect to exemplary embodiments, the principles disclosed may be applied to other types and applications of the production of carbon blacks from biomass feedstocks without departing from the scope herein.

### The Method:

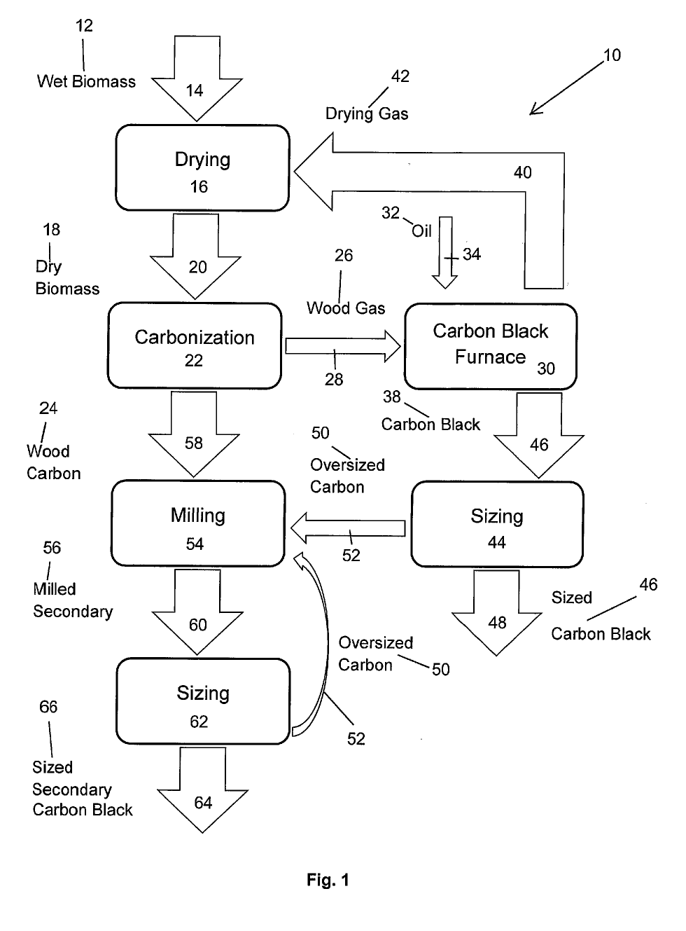

Referring now to FIG. 1, a flow diagram of a process 10 for the production and sizing of a solid carbon material from raw, untreated biomass illustrates the steps thereof in accordance with an embodiment of the instant invention. The initial steps required to create the novel composition of matter herein described include introducing wet or green biomass 12 via step 14 to drying apparatus 16 to produce biomass feedstock 18 of a selected moisture content and density. The dried biomass is introduced via step 20 to a carbonization reactor 22 where it is decomposed at high temperature (between approximately 350° C. and approximately 750° C.) sufficiently in a low oxygen environment to produce solid wood carbon 24 and wood or pyrolysis-gas 26. The carbonization may be accomplished through any number of processes which exist in the art, including external heating, steam pyrolysis, or staged pyrolysis as described in U.S. Pat. No. 9,505,984 B2. Any cost effective method for the fast or slow pyrolysis of biomass would be suitable for this process.

The pyrolysis-gas 26 is routed at step 28 to a carbon black furnace 30, which may be one of several types as known in the art. One such carbon black furnace is a cycling “thermal-black” variety in which only the pyrolysis gas 28 is be used to produce carbon black. In another embodiment of the present invention, carbon black is formed in the furnace 30 using the channel-black,” process, in which partially combusted pyrolysis gas impinges onto a cooled metal surface to produce carbon black. In yet another embodiment, the furnace may be of the “thermal furnace” type in which the wood or pyrolysis-gas 26 be used in combination with condensed pyrolysis oils, vegetable oils, or any other oil feedstock 32 introduced into the furnace at step 34 to fire the furnace producing a furnace or carbon black shown at 38. The carbonization processes in the furnaces disclosed above are carried out in a temperature range of approximately 400° C. to approximately 900° C. and for a length of time of which does not exceed five (5) seconds. The reactions disclosed above may utilize a water spray to control reaction temperatures and to provide nucleation sites for carbon black formation. Although three exemplary processes are disclosed in the embodiments noted herein, any reasonable method for carbon black production may be utilized with pyrolysis gases and oils to produce a carbon black product in a similar manner. Gaseous by-products of the carbon black production process may be directed via step 40 to the drying apparatus 16 where they may be used as a drying gas 42 to dry the wet biomass feedstock 12.

Once a carbon black 38 having a desired particle structure has been created, it is be collected in a baghouse, cyclone, air-classifier, or any number of collection apparatus which exist in the art and introduced to a sizing apparatus 44 at step 46 to form a sized carbon black at step 48, which is separated based on size in order to create various grades of carbon black for different uses. Oversized carbon 50 is conveyed at step 52 to a milling apparatus 54 where it is processed further into milled secondary carbon black 56. Wood carbon 24 produced in the carbon reactor 22 may also be introduced to the milling apparatus at step 58 where it is milled with the oversized carbon and combined therewith in the milled secondary carbon product 56. This product is introduced at step 60 into a second sizing apparatus 62 for further sizing to produce at step 64 a sized secondary carbon black 66. Any oversized carbon 50 present in the sized secondary carbon black 66 may be conveyed at step 52 back to the milling apparatus 54 for further processing.

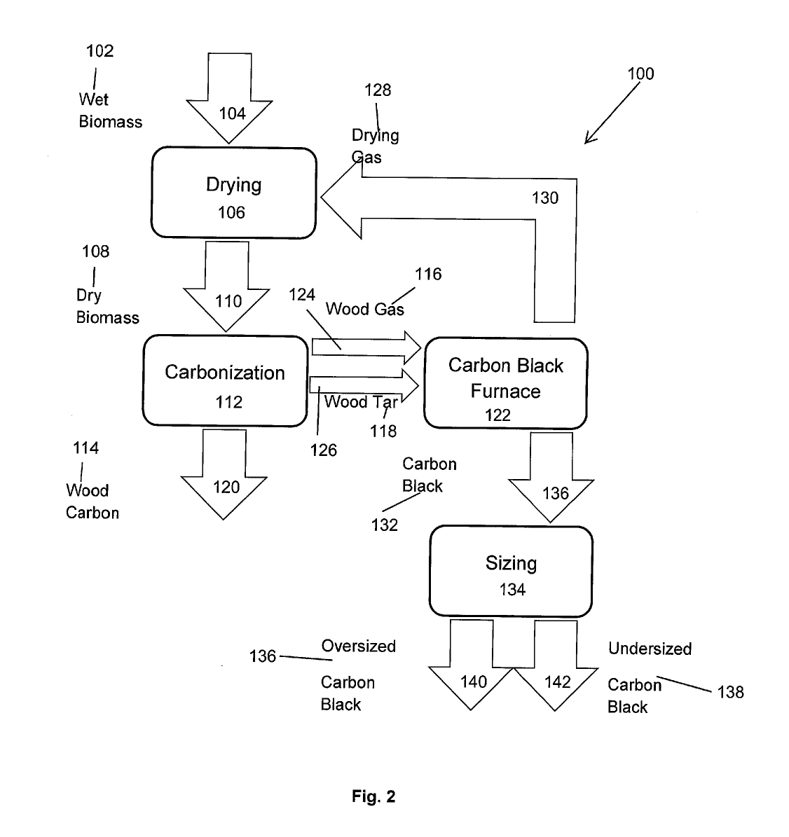

Referring now to FIG. 2, a process flow diagram illustrates the steps of a process 100 for producing and sizing carbon from wet raw biomass feedstock in accordance with an embodiment of the present invention. As described above with respect to the embodiment of FIG. 1, wet or green biomass 102 may be introduced via step 104 to drying apparatus 106 to produce biomass feedstock 108 of a selected moisture content and density.

The dried biomass 108 is introduced via step 110 to a carbonization reactor 112 where it is decomposed at high temperature (between approximately 350° C. and approximately 750° C.) under atmospheric temperature into solid wood carbon 114, wood gas 116 and wood tar 118. The wood carbon is discharges from the carbonization apparatus at step 120 for either further processing or for use in various applications. The wood gas and wood tar are be directed to a carbon black furnace 122 as shown at steps 124 and 126, respectively where both are processed to produce hot gas 128 for biomass drying as shown at step 130 and a carbon black product 132. The carbon black product is then introduced to a sizing apparatus 134 at step 136 where it is sized for specific applications and sorted into secondary oversized and undersized carbon black products 136 and 138 respectively, and delivered to an end user at steps 140, 142.

### The Product:

The material described herein has a number of primary and secondary properties and characteristics which make it ideal for use as a carbon black material. The primary properties include:

1. A composition of matter or particle created through the incomplete, over-rich, secondary pyrolysis of a hydrocarbon feedstock which is driven by the combustion of a pyrolysis derived gas;

2. A composition of matter or particle which has a high surface-area-to-volume ratio, having a surface area of approximately 10-600 m²/g;

3. A particle size below 45 microns (μm); which may be processed through sizing classification and milling to a desired size for specific applications, including but not limited to sizes in the range of approximately 6 μm to approximately 14 μm.

4. A specific gravity of less than approximately 1.4 g/cc.

5. Free of environmentally hazardous chemicals or compounds.

6. Deliverable to an end user as a granular powder or as an agglomerated pellet.

The secondary properties describe a composition of matter created through the pyrolysis of biomass which has been milled to a size and possesses specific properties such as density, hardness and chemical composition to provide superior properties as a reinforcement agent or pigment. These properties include, but are not limited to the functionalization of the carbon surface with hydrogen or oxygen groups to better interact with the compounds it is being mixed with. The composition may also include a total content of PAH's below 500 parts per billion and specific PAH compound concentrations to lower levels (such as Benzo(a)pyrene below 5 parts per billion). More specifically, the composition of matter has less than 5 μg/kg of polycyclic aromatic hydrocarbons including Acenaphthene, Acenaphthylene, Anthracene, Benzo(a)pyrene, Chrysene, Fluoranthene, Naphthalene, and Pyrene and other similar hazardous compounds. It also has less than 10 mg/kg of heavy metals such as Antimony, Arsenic, Barium, Cadmium, Chromium, Cobalt, Copper, Lead, Nickel, Mercury, or Selenium.

Changes may be made to the foregoing methods, devices and systems without departing from the scope of the present invention. It should be noted that the matter contained in the above description should be interpreted as illustrative and not in a limiting sense. The following claim(s) are intended to cover all generic and specific features described herein as well as statement of the scope of the present invention, which, as a matter of language, might be said to fall there between.

What is claimed is:

1. A method for the production of carbon black from raw untreated biomass sources comprising:
preprocessing the biomass feedstock to a preselected moisture content and density;
introducing treated biomass feedstock to a carbonization reactor;
pyrolytically decomposing the biomass feedstock in a controlled processing atmosphere at a preselected temperature for a preselected period of time to produce solid carbon material and wood gas;
introducing the wood gas and a feedstock oil to a carbon black furnace;
burning the wood gas in the carbon black furnace as a fuel at a preselected temperature for a preselected period of time to pyrolyze the feedstock oil to generate carbon black and hot drying gases adapted for use in the biomass preprocessing step;
sizing the carbon black;
introducing the solid carbon material to a milling apparatus;
milling the solid carbon material to a preselected size to create a milled carbon black; and
sizing the milled carbon black.

2. The method of claim 1 where the pyrolization in the carbon black furnace occurs at temperature in a range of approximately 400° C. to approximately 900° C. for a length of time which does not exceed five (5) seconds and the method of carbon black production is the thermal process.

3. The method of claim 1 where the carbonization pyrolization in the carbon black furnace occurs at temperature in a range of approximately 400° C. to approximately 900° C. for a length of time which does not exceed five (5) seconds and the method of carbon black production is the channel process.

4. The method of claim 1 where the carbonization pyrolization in the carbon black furnace occurs at temperature in a range of approximately 400° C. to approximately 900° C. for a length of time which does not exceed five (5) seconds and the method of carbon black production is the furnace process

5. The method of claim 4 further including the step of utilizing the pyrolysis gas to heat the system and the pyrolysis oils as a feedstock for carbon black production.

6. The method of claim 5 including the step of blending the carbon material produced in the pyrolysis process with the carbon black to adjust carbon black properties and to reduce costs.

7. A material which can be used as a filler or reinforcing agent or as a replacement for traditional carbon blacks which had been produced from biomass sources through pyrolytic decomposition to create pyrolysis gases and oils which are subsequently heated in absence of oxygen to form the material, the material having a fixed carbon content greater than approximately 90%.

8. The material of claim 7 further having a surface area (measured with nitrogen adsorption) of between 10-600 m²/g.

9. The material of claim 7 further having a specific gravity of less than 1.4 g/cc.

10. The material of claim 7 wherein the material is free of environmentally hazardous chemicals or compounds.

11. The material of claim 10 which has less than 5 μg/kg of polycyclic aromatic hydrocarbons including Acenaphthene, Acenaphthylene, Anthracene, Benzo(a)pyrene, Chrysene, Fluoranthene, Naphthalene, and Pyrene and other similar hazardous compounds and less than 10 mg/kg of heavy metals such as Antimony, Arsenic, Barium, Cadmium, Chromium, Cobalt, Copper, Lead, Nickel, Mercury, or Selenium.

12. The material of claim 7, which is transported and delivered to the user as a granular powder.

13. The material of claim 7, which is transported and delivered to the user as an agglomerated pellet.
